(19) United States
(12) Patent Application Publication
(10) Pub. No.: US 2022/0018483 A1
(43) Pub. Date: Jan. 20, 2022

(54) PIPELINE SCRAPER ASSEMBLIES INCLUDING WEAR INDICATORS AND METHODS FOR USING THE SAME

(71) Applicant: Saudi Arabian Oil Company, Dhahran (SA)

(72) Inventor: Husain M. Al-Muslim, Dammam (SA)

(73) Assignee: Saudi Arabian Oil Company, Dhahran (SA)

(21) Appl. No.: 16/930,728

(22) Filed: Jul. 16, 2020

(51) Int. Cl. F16L 55/42

(52) U.S. Cl. CPC F16L 55/42; F16L 2101/12

(57) ABSTRACT

A pipeline scraper assembly including a guide disc, and a sealing disc coupled to the guide disc, where the sealing disc defines a sealing disc outer circumference, and an initial wear indicator defining an initial radially-facing wear face that is positioned radially inward from the sealing disc outer circumference by an initial wear distance, and a secondary wear indicator defining a secondary radially-facing wear face that is positioned radially inward from the sealing disc outer circumference by a secondary wear distance, where the secondary wear distance is greater than the initial wear distance.

### BACKGROUND

### Field

The present disclosure relates to pipeline scraper assemblies, and more particularly, pipeline scraper assemblies including wear indicators and methods for using the same.

### Technical Background

Pipeline scraper assemblies, sometimes referred to as “pigs” or “pipeline pigs” can be utilized to clean and/or inspect the pipes of pipelines. The pipeline scraper assemblies can be inserted within the pipe, and may be propelled along the pipe as material (e.g., gases and/or fluids) moves through the pipe.

### BRIEF SUMMARY

Pipeline scraper assemblies generally include discs that are engaged with the sidewall of the pipe. For example, the discs may be slidably engaged with the sidewalls of the pipe, and material moving through the pipe may move the discs (and accordingly the pipeline scraper assembly) along the sidewall of the pipe. Engagement between the discs and the sidewall of the pipe may “scrape” debris or buildup on the sidewall of the pipe, thereby cleaning the pipe. The pipeline scraper assemblies may be inserted into the pipes, travel along the pipe or a discrete section of the pipe, and may subsequently removed and reused. Over time, engagement between the sidewall of the pipe and the discs cause the discs to wear, reducing the diameter of the discs. Eventually, the diameter of the discs may decrease such that the diameter of the discs is less than an inner diameter of the pipe. In these circumstances, when the pipeline scraper assemblies are inserted within a pipe some or all of the discs may be disengaged from the sidewall of the pipe, which may allow the pipeline scraper assembly to become misaligned with the pipe. Misalignment with the pipe may allow the pipeline scraper assembly to become stuck within the pipe. Retrieval of the stuck pipeline scraper assembly may be costly and time-consuming, and the stuck pipeline scraper assembly may reduce throughput of the pipe. Accordingly, a need exists for improved pipeline scraper assemblies and methods for using pipeline scraper assemblies.

Embodiments of the present disclosure are generally directed to pipeline scraper assemblies that include wear indicators that provide a visual indication to a user when the pipeline scraper assemblies should be serviced, and a sealing disc of the pipeline scraper assembly should be replaced.

In one embodiment, a pipeline scraper assembly including a guide disc, and a sealing disc coupled to the guide disc, where the sealing disc defines a sealing disc outer circumference, and an initial wear indicator defining an initial radially-facing wear face that is positioned radially inward from the sealing disc outer circumference by an initial wear distance, and a secondary wear indicator defining a secondary radially-facing wear face that is positioned radially inward from the sealing disc outer circumference by a secondary wear distance, where the secondary wear distance is greater than the initial wear distance.

In another embodiment, a pipeline scraper assembly includes a guide disc, and a sealing disc coupled to the guide disc, where the sealing disc defines a sealing disc outer circumference, and an initial wear indicator defining an initial radially-facing wear face, where the initial wear indicator defines an unobstructed line of sight with at least one of a leading edge plane of the pipeline scraper assembly, a trailing edge plane of the pipeline scraper assembly, and a radial edge plane of the pipeline scraper assembly defined by the sealing disc outer circumference, and a secondary wear indicator defining a secondary radially-facing wear face, where the secondary wear indicator defines an unobstructed line of sight with at least one of the leading edge plane of the pipeline scraper assembly, the trailing edge plane of the pipeline scraper assembly, and the radial edge plane of the pipeline scraper assembly.

In yet another embodiment, method for scraping a pipe of a pipeline includes positioning a pipeline scraper assembly within the pipe, where the pipeline scraper assembly includes a sealing disc, engaging an outer circumference of the sealing disc of the pipeline scraper assembly with a sidewall of the pipe, removing the pipeline scraper assembly from the pipe, determining whether an initial wear indicator is visible, the initial wear indicator defining an initial wear face that is positioned radially inward from a sealing disc outer circumference by an initial wear distance, and determining whether a secondary wear indicator is visible, the secondary wear indicator defining a secondary wear face that is positioned radially inward from the sealing disc outer circumference by a secondary wear distance, where the secondary wear distance is greater than the initial wear distance.

Additional features and advantages of the technology disclosed in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a section view of a pipeline scraper assembly, according to one or more embodiments shown and described herein;

FIG. 2A schematically depicts a section view of a sealing disc of a pipeline scraper assembly, according to one or more embodiments shown and described herein;

FIG. 2B schematically depicts a section view of another sealing disc of a pipeline scraper assembly, according to one or more embodiments shown and described herein;

FIG. 2C schematically depicts a section view of another sealing disc of the pipeline scraper assembly of FIG. 1, according to one or more embodiments shown and described herein;

FIG. 3 schematically depicts a front view of a sealing disc of the pipeline scraper assembly of FIG. 1, according to one or more embodiments shown and described herein;

FIG. 4 schematically depicts a side view of a sealing disc of FIG. 3, according to one or more embodiments shown and described herein;

FIG. 5 schematically depicts a section view of the sealing disc of FIG. 4 along section 5-5, according to one or more embodiments shown and described herein;

FIG. 6A schematically depicts a front view of another sealing disc, according to one or more embodiments shown and described herein; and

FIG. 6B schematically depicts a section view of the sealing disc of FIG. 6A along section 6B-6B, according to one or more embodiments shown and described herein.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

Embodiments of the present disclosure are generally directed to pipeline scraper assemblies that include wear indicators that provide a visual indication to a user when the pipeline scraper assemblies should be serviced, and a sealing disc of the pipeline scraper assembly should be replaced. These and other embodiments will now be described with reference to the appended drawings.

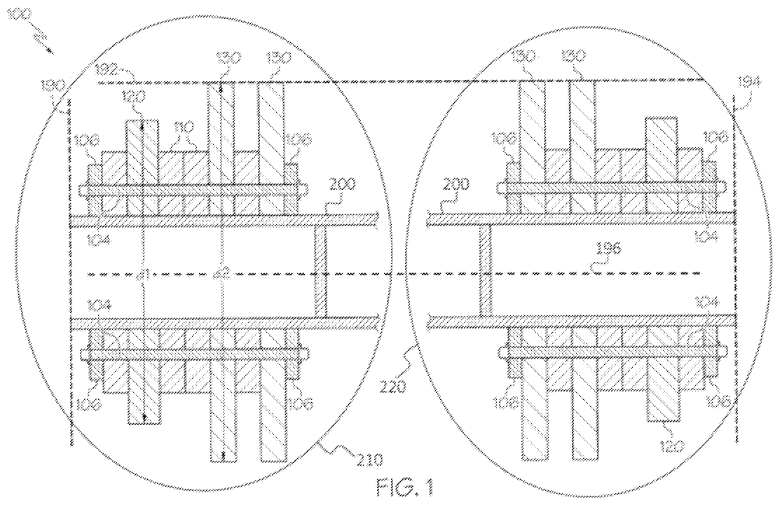

Referring initially to FIG. 1, a section view of a pipeline scraper assembly 100 is schematically depicted. In embodiments the pipeline scraper assembly 100 includes one or more guide discs 120 and one or more one or more sealing discs 130. In embodiments, the guide discs 120 and/or the sealing discs 130 may each define shapes that are complementary with the shape of a pipe of a pipeline. For example, in some embodiments, the guide discs 120 may be cylindrically-shaped, however, it should be understood that this is merely an example.

In embodiments, the guide discs 120 define a guide disc diameter d1, and the sealing discs 130 define a sealing disc diameter d2. In some embodiments the sealing disc diameter d2 is great than the guide disc diameter d1. In embodiments, the guide disc diameter d1 of the guide discs 120 may be selected to be smaller than an inside diameter of a corresponding pipe. For example, in some embodiments, the guide disc diameter d1 may be selected to be between about 95% and about 99% of a diameter of a corresponding pipe, inclusive of the endpoints. In some embodiments, the sealing disc diameter d2 of the sealing discs 130 may be selected to be larger than the diameter of the corresponding pipe. For example, in some embodiments, the sealing disc diameter d2 may be selected to be between about 103% and about 108% of the diameter of the corresponding pipe. In embodiments, the guide discs 120 and/or the sealing discs 130 may be formed of materials that can elastically deform within the pipe of a pipeline. For example, in some embodiments, the guide discs 120 and the sealing discs 130 may be formed from one or more thermoplastics, for example and without limitation, polyurethane, polyethylene, ultra high molecular weight (UHMW) polyethylene, or the like. In some embodiments the guide discs 120 and/or the sealing discs 130 may be formed of materials comprising a hardness between about 65 shore A hardness and about 75 shore A hardness, inclusive of the endpoints.

In operation, the guide discs 120 may assist in centering the pipeline scraper assembly 100 within a pipe. The sealing discs 130 are structurally configured to engage sidewall or sidewalls of the pipe. In embodiments in which the sealing disc diameter d2 is larger than the diameter of the pipe, the sealing discs 130 may engage the sidewall or sidewalls of the pipe, and the one or more sealing discs 130 may elastically deform to fit within the pipe.

In embodiments, the pipeline scraper assembly 100 may include one or more retainers 104. The one or more retainers 104 may couple the guide discs 120 to the sealing discs 130. For example, in the embodiment depicted in FIG. 1, the one or more retainers 104 may be engaged with flanges 106 that engage and couple the guide discs 120 to the sealing discs 130. The one or more retainers 104 may include any suitable construction to couple the guide discs 120 to the sealing discs 130, and may include for example and without limitation, a threaded bolt, a shaft, or the like.

In some embodiments, the pipeline scraper assembly 100 includes one or more spacers 110 positioned between the one or more guide discs 120 and the one or more sealing discs 130. For example, in the embodiment depicted in FIG. 1, each of the guide discs 120 are axially spaced apart from the sealing discs 130 by one or more spacers 110. While in the embodiment depicted in FIG. 1, the pipeline scraper assembly 100 includes two guide discs 120 and four sealing discs 130, it should be understood that this is merely an example, and the pipeline scraper assembly 100 may include any suitable number of guide discs 120 and sealing discs 130.

In operation, material (e.g., fluid and/or gas) is passed through the pipe, and the pipeline scraper assembly 100 may be positioned within the pipe. The pipeline scraper assembly 100 may be propelled along the pipe by the moving material (e.g., the fluid and/or gas). For example, the material (e.g., the fluid and/or gas) may apply pressure to the one or more sealing discs 130 and/or the one or more guide discs 120 in a direction of travel to propel the pipeline scraper assembly 100 along the pipe.

Because the sealing discs 130 generally define the sealing disc diameter d2 that is greater than the diameter of the pipe, the one or more sealing discs 130 may generally engage the sidewall of the pipe as the pipeline scraper assembly 100 travels along the pipe. The sealing discs 130 may engage and dislodge blockages as the pipeline scraper assembly 100 moves along the pipe, thereby assisting in maintaining flow of material through the pipe.

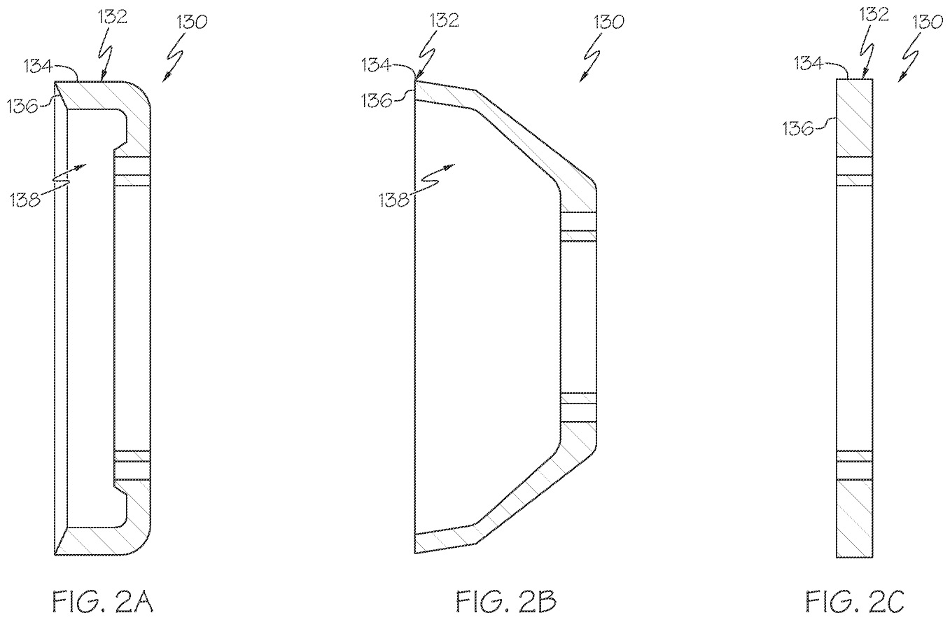

Referring to FIG. 2A, a cross-section of an example sealing disc 130 is schematically depicted. In embodiments, the sealing disc 130 generally defines a sealing disc outer circumference 132 having an engagement surface 134 that is structurally configured to engage the sidewall of a pipe. In embodiments, the sealing disc 130 may include any suitably shaped cross-sections. In some embodiments and as depicted in FIG. 2A, the sealing disc 130 may include a “c-shaped” cross-section defining a concave surface 138 positioned inward of the sealing disc outer circumference 132. In some embodiments and referring to FIG. 2B, the sealing disc 130 may include a “bowl-shaped” cross-section defining the concave surface 138 positioned inward of the sealing disc outer circumference 132. In some embodiments and referring to FIG. 2C, the sealing disc 130 may define a cylindrical shape.

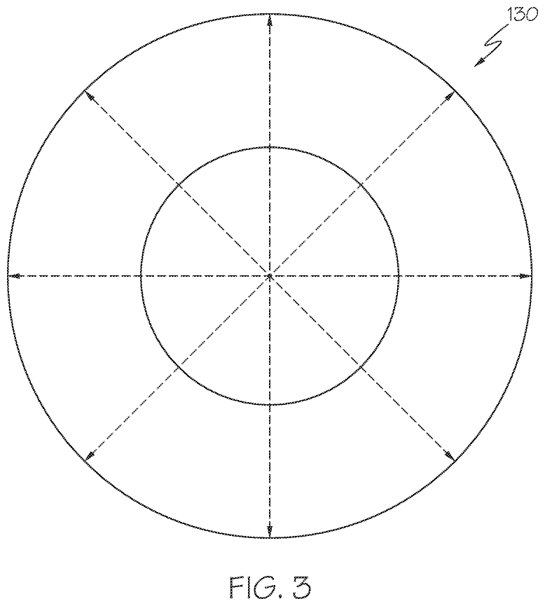

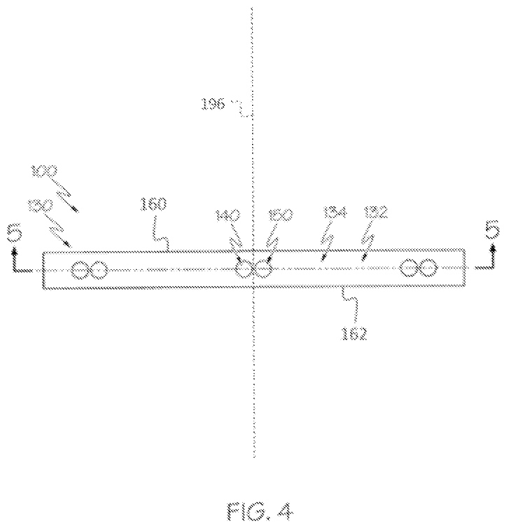

Referring to FIGS. 3 and 4, a front view and a side view of an example sealing disc 130 are schematically depicted, respectively. In embodiments, the sealing disc 130 defines an initial wear indicator 140 and a secondary wear indicator 150. In the embodiment depicted in FIG. 4 the initial wear indicator 140 and the secondary wear indicator 150 are positioned on the sealing disc outer circumference 132 of the sealing disc 130.

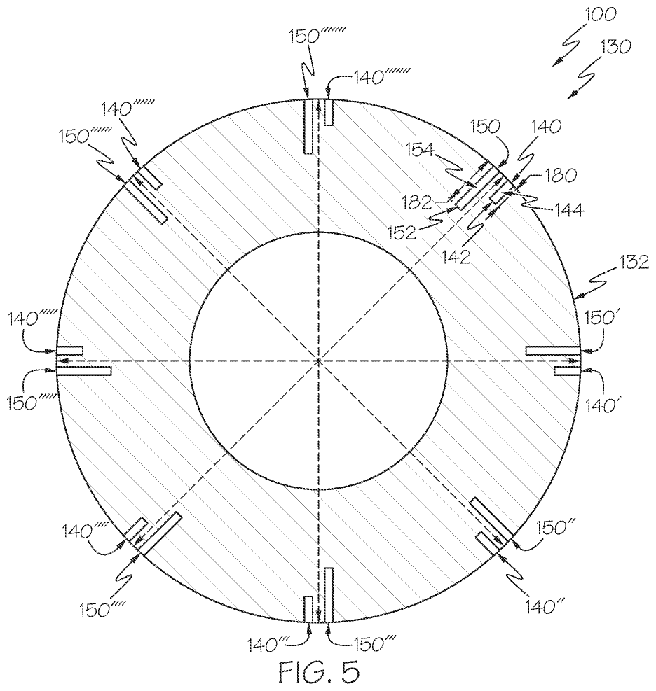

Referring to FIG. 5, a section view of the sealing disc 130 along section 5-5 of FIG. 4 is schematically depicted. In embodiments, the initial wear indicator 140 defines an initial radially-facing surface 142 that is positioned radially inward from the sealing disc outer circumference 132 by an initial wear distance 180. The secondary wear indicator 150 defines a secondary radially-facing surface 152 that is positioned radially inward from the sealing disc outer circumference 132 by a secondary wear distance 182 that is different than the primary wear distance 180.

For example, in the embodiment depicted in FIG. 5, the initial wear indicator 140 defines a channel 144 extending radially inward from the sealing disc outer circumference 132 to the initial radially-facing surface 142. The secondary wear indicator 150 defines a channel 154 extending radially inward from the sealing disc outer circumference 132 to the secondary radially-facing surface 152. The primary wear indicator 140 and/or the secondary wear indicator 150 may be formed in the sealing disc 130 through any suitable process, for example and without limitation, molding or machining.

In operation, the pipeline scraper assembly 100 may be positioned within the pipe of a pipeline at an insertion point, may travel along a discrete portion of the pipe, and may be removed from the pipe at a retrieval point. After removal from the pipe, the pipeline scraper assembly 100 may be re-inserted within the pipe (or within a different pipe). Over time, the sealing discs 130 may wear, thereby decreasing the sealing disc diameter d2 (FIG. 1). As the sealing disc diameter d2 (FIG. 1) decreases, the sealing disc diameter d2 (FIG. 1) may eventually become smaller than the diameter of the pipe, which may allow the pipeline scraper assembly to become misaligned with and stuck within the pipe, thereby blocking the flow of material through the pipe. In such circumstances, the pipeline scraper assembly may need to be removed from the pipe, for example, by cutting the pipe and removing the pipeline scraper assembly 100. In some applications, for example in oil and gas applications, pipes of pipelines may extend through locations and terrain that are difficult to access. Accordingly, the pipeline scraper assembly may become stuck in a location or terrain that is difficult to access, and removal of a stuck pipeline scraper assembly may be costly and time consuming. Additionally, the stuck pipeline scraper assembly may partially or fully block the flow of material through the pipe, thereby decreasing productivity of the pipeline until the pipeline scraper assembly is removed.

In embodiments described herein, as the sealing disc 130 wears, the sealing disc outer circumference 132 decreases, such that the sealing disc outer circumference 132 moves radially inward. As the sealing disc outer circumference 132 moves radially inward, the sealing disc outer circumference 132 moves toward the initial radially-facing surface 142. When the sealing disc outer circumference 132 has worn through the initial wear distance 180, the sealing disc outer circumference 132 may merge with the initial radially-facing surface 142. In other words, when the sealing disc outer circumference 132 has worn through the initial wear distance 180, the sealing disc outer circumference 132 will have worn through the initial wear indicator 140, such that the initial wear indicator 140 is no longer visible.

As the sealing disc 130 continues to wear, the sealing disc outer circumference 132 continues to move radially inward toward the secondary radially-facing surface 152. When the sealing disc outer circumference 132 has worn through the secondary wear distance 182, the sealing disc outer circumference 132 may merge with the secondary radially-facing surface 152. In other words, when the sealing disc outer circumference 132 has worn through the secondary wear distance 182, the sealing disc outer circumference 132 will have worn through the secondary wear indicator 150, such that the secondary wear indicator 150 is no longer visible.

Accordingly, as the pipeline scraper assembly 100 is used and re-used, a user such as a technician or the like can estimate the amount of wear to the one or more sealing discs 130 by viewing the initial wear indicator 140 and the secondary wear indicator 150. For example, in response to determining that both the initial wear indicator 140 and the secondary wear indicator 150 are visible, the user may determine that the sealing disc outer circumference 132 has not yet worn through the initial wear distance 180. In response to determining that the initial wear indicator 140 is no longer visible, and the secondary wear indicator 150 is visible, the user may determine that the sealing disc outer circumference 132 has worn through the initial wear distance 180, but has not yet worn through the secondary wear distance 182. In response to determining that neither the initial wear indicator 140 nor the secondary wear indicator 150 are visible, the user may determine that the sealing disc outer circumference 132 has worn through the initial wear distance 180 and the secondary wear distance 182.

In embodiments, the initial radially-facing surface 142 and the secondary radially-facing surface 152 may be formed in the sealing disc 130 such that the initial wear distance 180 and the secondary wear distance 182 are associated with configurable maintenance thresholds of the sealing disc 130. For example, the initial wear distance 180 may be selected to indicate an amount of wear at which the sealing disc 130 may still be utilized, but should be scheduled for maintenance. The secondary wear distance 182 may be selected to indicate an amount of wear at which the pipeline scraper assembly 100 should be removed from service, and the sealing disc 130 should be removed and replaced with a new sealing disc 130. Accordingly, the initial wear indicator 140 and the secondary wear indicator 150 may assist in managing the maintenance of the pipeline scraper assembly 100, and more particularly sealing disc 130. In some embodiments, the secondary wear distance 182 is at least twice the initial wear distance 180.

In some embodiments and still referring to FIG. 5, the sealing disc 130 may include multiple initial wear indicators 140 and multiple secondary wear indicators 150. For example, in the embodiment depicted in FIG. 5, the sealing disc 130 includes the initial wear indicator 140, a second initial wear indicator 140′, a third initial wear indicator 140″, a fourth initial wear indicator 140′″, a fifth initial wear indicator 140″″, a sixth initial wear indicator 140′″″, a seventh initial wear indicator 140″″″, and an eighth initial wear indicator 140′″″″ that are each spaced apart from one another along the sealing disc outer circumference 132 of the sealing disc 130. In the embodiment depicted in FIG. 5, the sealing disc includes the secondary wear indicator 150, a second secondary wear indicator 150′, a third secondary wear indicator 150″, a fourth secondary wear indicator 150′″, a fifth secondary wear indicator 150″″″, a sixth secondary wear indicator 150′″″, a seventh secondary wear indicator 150″″″, and an eighth secondary wear indicator 150′″″″ that are each spaced apart from one another along the sealing disc outer circumference 132. By including multiple initial wear indicators 140 and secondary wear indicators 150 that are spaced apart from one another along the sealing disc outer circumference 132, wear at different positions along the sealing disc outer circumference 132 may be determined. For example, in some instances, the sealing disc 130 may wear unevenly about the sealing disc outer circumference 132, and some portions of the sealing disc outer circumference 132 may wear at different rates. Accordingly, by including multiple wear initial wear indicators 140 and secondary wear indicators 150 that are spaced apart from one another along the sealing disc outer circumference 132, a user may determine the amount of wear at different areas of the sealing disc outer circumference 132. While in the embodiment depicted in FIG. 5, the sealing disc 130 includes eight initial wear indicators 140 and eight secondary wear indicators 150, it should be understood that the sealing disc 130 may include any suitable number or initial wear indicators 140 and secondary wear indicators 150 spaced apart from one another along the sealing disc outer circumference 132 at any suitable spacing. Further, while the initial wear indicators 140 and the secondary wear indicators 150 depicted in FIG. 5 define cylindrical channels 144, 154, it should be understood that this is merely an example. In embodiments according to the present disclosure, the initial wear indicators 140 and the secondary wear indicators 150 may define any suitable shape, for example and without limitation, rectangular shapes, triangular shapes, and/or alpha-numeric shapes, or the like extending inward from the sealing disc outer circumference 132.

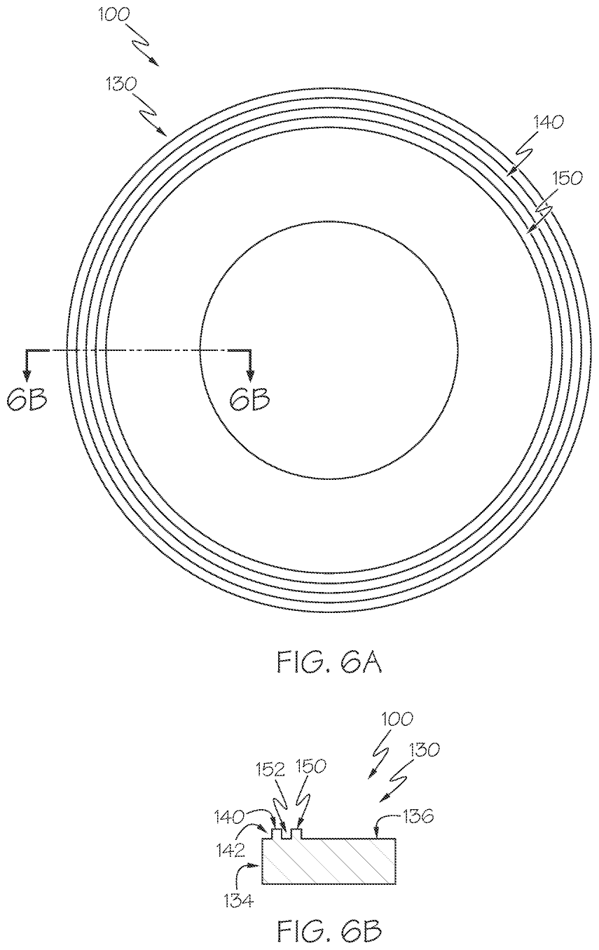

Referring to FIGS. 6A and 6B, a front view and a section view of another example sealing disc 130 are schematically depicted, respectively. In the embodiment depicted in FIG. 6A, the sealing disc 130 includes the initial wear indicator 140 and the secondary wear indicator 150 including the initial radially-facing surface 142 and the secondary radially-facing surface 152, respectively. However, in the embodiment depicted in FIG. 6A, the initial wear indicator 140 and the secondary wear indicator 150 are positioned on a transverse surface 136 of the sealing disc 130. For example, in the embodiment depicted in FIG. 6A, the sealing disc 130 defines a transverse surface 136 that is oriented transverse to the engagement surface 134, and at least one of the initial wear indicator 140 and the secondary wear indicator 150 are positioned on the transverse surface 136. In the embodiment depicted in FIG. 6B, the initial wear indicator 140 and the secondary wear indicator 150 each extend outward from the transverse surface 136 (e.g., as positive features). In some embodiments, the initial wear indicator 140 and/or the secondary wear indicator 150 may extend inward into the transverse surface 136 (e.g., as negative cutout features).

Referring again to FIG. 1, in some embodiments, the initial wear indicator 140 and/or the secondary wear indicator 150 enjoy an unobstructed line of sight with at least one of a leading edge plane 190, a trailing edge plane 194, and a radial edge plane 192 of the pipeline scraper assembly 100. For example, in embodiments, the pipeline scraper assembly 100 defines the leading edge plane 190 at a front portion of the pipeline scraper assembly 100 and the trailing edge plane 194 at a rear portion of the pipeline scraper assembly 100. The sealing disc outer circumference 132 of the sealing disc 130, in embodiments, may define an infinite number of radial edge planes 192 that are tangent to the sealing disc outer circumference 132.

In some embodiments, for example, in embodiments in which the initial wear indicator 140 (FIG. 6A) and/or the secondary wear indicator 150 (FIG. 6A) are formed on the transverse surface 136 (FIG. 6A) of the sealing disc 130, the initial wear indicator 140 and/or the secondary wear indicator 150 may enjoy an unobstructed line of sight with the leading edge plane 190 or the trailing edge plane 194. In some embodiments, the initial wear indicator 140 (FIG. 5) and/or the secondary wear indicator 150 (FIG. 5) may enjoy an unobstructed line of sight with a radial edge plane 192, for example, in embodiments in which the initial wear indicator 140 and the secondary wear indicator 150 extend inward from the sealing disc outer circumference 132, as shown in FIG. 5, and/or in embodiments in which the initial wear indicator 140 and/or the secondary wear indicator 150 are positioned on the transverse surface 136 as shown in FIG. 6B. By forming the initial wear indicator 140 and/or the secondary wear indicator 150 to have an unobstructed line of sight with at least one of the leading edge plane 190, the trailing edge plane 194, and the radial edge plane 192, the initial wear indicator 140 and/or the secondary wear indicator 150 may be readily viewed by a user after the pipeline scraper assembly 100 is utilized.

Accordingly, it should now be understood that embodiments of the present disclosure are generally directed to pipeline scraper assemblies that include wear indicators that provide a visual indication to a user when the pipeline scraper assemblies should be serviced, and a sealing disc of the pipeline scraper assembly should be replaced.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the appended claims should be taken as the sole representation of the breadth of the present disclosure and the corresponding scope of the various embodiments described in this disclosure. Further, it should be apparent to those skilled in the art that various modifications and variations can be made to the described embodiments without departing from the spirit and scope of the claimed subject matter. Thus it is intended that the specification cover the modifications and variations of the various described embodiments provided such modification and variations come within the scope of the appended claims and their equivalents.

It is noted that recitations herein of a component of the present disclosure being “structurally configured” in a particular way, to embody a particular property, or to function in a particular manner, are structural recitations, as opposed to recitations of intended use. More specifically, the references herein to the manner in which a component is “structurally configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the terms “substantially” and “about” are utilized herein to represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A pipeline scraper assembly comprising a leading pipeline scraper member and a trailing pipeline scraper member positioned at opposite ends of a linear pipeline scraper assembly shaft along a central axis of the linear pipeline scraper assembly shaft, wherein:
the leading pipeline scraper member and the trailing pipeline scraper member each comprise a guide disc and a sealing disc coupled to the guide disc;
the sealing disc comprises a sealing disc outer circumference and an engagement surface on the sealing disk outer circumference, the engagement surface being parallel to the central axis of the linear pipeline scraper assembly shaft;
the sealing disc further comprises an initial wear indicator and an secondary wear indicator;
the initial wear indicator is a bore formed within the thickness of the sealing disc between a leading face and a trailing face of the sealing disc, extending radially inward from the engagement surface by an initial wear distance;
the secondary wear indicator is a bore formed within the thickness of the sealing disc between the leading face and the trailing face of the sealing disc, extending radially inward from the engagement surface by a secondary wear distance; and
the secondary wear distance is greater than the initial wear distance.

2. (canceled)

3. The pipeline scraper assembly of claim 1, wherein the engagement surface is structurally configured to engage a sidewall of a pipe.

4-5. (canceled)

6. The pipeline scraper assembly of claim 1, wherein the initial wear indicator and the secondary wear indicator each define an unobstructed line of sight with at least one of a leading edge plane of the pipeline scraper assembly and a trailing edge plane of the pipeline scraper assembly.

7. The pipeline scraper assembly of claim 1, wherein the initial wear indicator and the secondary wear indicator each define an unobstructed line of sight with a radial edge plane of the pipeline scraper assembly defined by the sealing disc outer circumference.

8. The pipeline scraper assembly of claim 1, wherein the guide disc is axially spaced apart from the sealing disc.

9. The pipeline scraper assembly of claim 1, wherein the initial wear indicator is a first initial wear indicator, and the sealing disc defines a second initial wear indicator spaced apart from the first initial wear indicator on the sealing disc outer circumference.

10. The pipeline scraper assembly of claim 1, wherein:
at least one of the initial wear indicator and the secondary wear indicator defines an unobstructed line of sight with at least one of a leading edge plane of the pipeline scraper assembly, a trailing edge plane of the pipeline scraper assembly, and a radial edge plane of the pipeline scraper assembly defined by the sealing disc outer circumference;
the initial wear indicator is a first initial wear indicator, and the sealing disc comprises a second initial wear indicator spaced apart from the first initial wear indicator on the engagement surface; and
the guide disc is axially spaced apart from the sealing disc.

11-16. (canceled)

17. The pipeline scraper assembly of claim 1, wherein, the sealing disc defines a concave surface positioned inward of the sealing disc outer circumference.

18. A method for scraping a pipe of a pipeline, the method comprising:
positioning the pipeline scraper assembly, as claimed in claim 1, within the pipe;
engaging the engagement surface of the pipeline scraper assembly with a sidewall of the pipe;
removing the pipeline scraper assembly from the pipe;
determining whether an initial wear indicator is visible; and
determining whether a secondary wear indicator is visible.

19. The method of claim 18, further comprising in response to determining that the initial wear indicator and the secondary wear indicator are not visible, removing the sealing disc from the pipeline scraper assembly and installing a second sealing disc to the pipeline scraper assembly.

20. (canceled)
